(19) United States
(12) Patent Application Publication
(10) Pub. No.: US 2005/0043066 A1
(43) Pub. Date: Feb. 24, 2005

(54) Method and system for controlling notification of call reception in a mobile terminal

(76) Inventor: Sang-Uk Seo, Daegu (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/921,844

(22) Filed: Aug. 20, 2004

(30) Foreign Application Priority Data
Aug. 23, 2003 (KR) 2003-58497

(51) Int. Cl. H04B 1/38

(52) U.S. Cl. 455/567; 455/550.1

(57) ABSTRACT

A method and system of controlling a notification of a call reception in a mobile terminal is disclosed. The method and system comprises a caller setting a type of reception notification in a receiver terminal and requesting a communication; judging whether or not an automatic change of the type of reception notification has been set when the communication request is received in the receiver terminal; determining whether or not a dialed telephone number is a registered number when the automatic change of the type of reception notification has been set; checking the type of reception notification of a calling party transmitted by the caller when the dialed telephone number is the registered number; comparing the type of reception notification of the calling party with the type of reception notification set in the receiver terminal; and changing the type of reception notification set in the receiver terminal as the type of reception notification of the calling side and reporting a call reception when the type of reception notification of the calling party does not match the type of reception notification set in the receiver terminal.

### PRIORITY

This application claims priority under 35 U.S.C. § 119(a) to an application entitled “Method for controlling notification of call reception in mobile terminal” filed in the Korean Intellectual Property Office on Aug. 23, 2003 and assigned Serial No. 2003-58497, the entire contents of which are incorporated herein by reference.

### BACKGROUND OF THE INVENTION

1. Field of the Invention

The present invention relates to a method and system for controlling a notification of a call reception in a mobile terminal. More particularly, the present invention relates to a method and system by which a caller terminal can control the type of call reception notification of a receiver terminal.

2. Description of the Related Art

When a call is received in a mobile terminal, the mobile terminal typically informs a user of a call reception according to the type of reception notification set in advance by the user. If reception notification of the mobile terminal is set to no-sound or vibration and the mobile terminal is separated from the user's body, when an emergency call is received, the user may not recognize the call reception due to the reception notification being set to the no-sound or the vibration mode. Further, if a user has frequent meetings, when the meeting is progressing and the user has not set the type of reception notification to the no-sound or the vibration mode, a bell rings for all incoming calls. Therefore, the meeting is interrupted by the ring. Furthermore, a reception notification that is not suitable for a situation such as a public place or sleeping environment may cause a disturbance to others.

### SUMMARY OF THE INVENTION

Accordingly, the present invention has been made to solve the above-mentioned problems occurring in the prior art, and a first object of the present invention is to provide a method and system for reporting a call reception of a receiver terminal by setting the type of reception notification set by a caller terminal to the type of reception notification of the receiver terminal.

In order to accomplish the aforementioned object, according to one aspect of the present, there is provided a method and system for controlling a notification of a call reception in a mobile terminal. The method and system comprises a caller setting a type of reception notification in a receiver terminal and requesting a communication; judging whether or not an automatic change of the type of reception notification has been set when the communication request is received in the receiver terminal; checking a type of reception notification of a calling party transmitted by the caller when the automatic change of the type of reception notification has been set; comparing the type of reception notification of the calling party with the type of reception notification set in the receiver terminal; and changing the type of reception notification set in the receiver terminal to the type of reception notification of the calling party and reporting a call reception when the type of reception notification of the calling side does not match with the type of reception notification set in the receiver terminal.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of a mobile terminal with a camera according to an embodiment of the present invention;

FIG. 2 is a flowchart illustrating a process in which a caller terminal sets and transmits reception notification of a receiver terminal according to an embodiment of the present invention;

FIG. 3 is a flowchart illustrating a process in which a base station sets up the type of reception notification set by a caller terminal and transmits it to a receiver terminal according to an embodiment of the present invention;

FIG. 4 is a diagram illustrating an information format transmitted from the base station of FIG. 3 to a receiving terminal;

FIGS. 5A and 5B are flowcharts illustrating a process in which a receiver terminal sets an automatic change for the type of reception notification according to an embodiment of the present invention;

FIG. 6 is a flowchart illustrating a process in which the type of reception notification of a receiver terminal is controlled according to an embodiment of the present invention; and

FIG. 7 is a flowchart illustrating a process for reporting a call reception according to an embodiment of the present invention.

In the drawings, it should be understood that the same reference numerals are used to designate the same elements as those shown in other drawings.

### DETAILED DESCRIPTION OF THE PREFERRED EMBODIMENTS

Embodiments of the present invention will now be described with reference to the accompanying drawings. In the following description of the present invention, exemplary types of delimitation marks for reception notification or the type of reception notification, are shown in order to provide a better understanding of the present invention. It should be understood by those skilled in the art that the present invention can be practiced without the specific examples.

In an embodiment of the present invention, a call reception notification is a method of notifying a user of a call occurrence when a voice call occurs in a mobile terminal. The type of call reception notification may include a bell/melody, a vibration, and a non-sound (lamp or LED flickering)

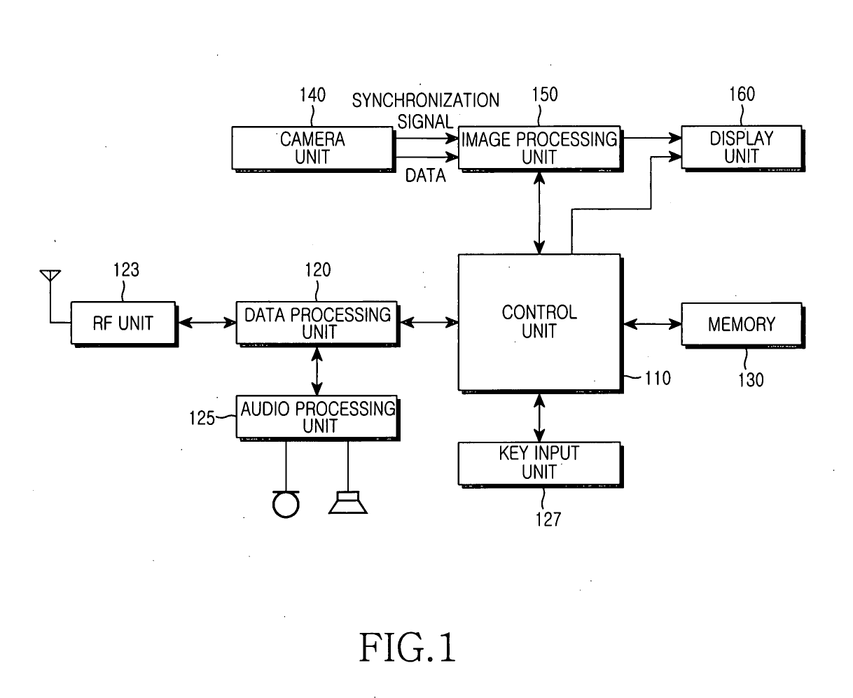

FIG. 1 is a block diagram of a mobile terminal with a camera according to an embodiment of the present invention.

Referring to FIG. 1, the mobile terminal with the camera according to the present invention includes a radio frequency (RF) unit 123, a data processing unit 120, an audio processing unit 125, a memory 130, a control unit 110, a camera unit 140, an image processing unit 150, a display unit 160, and a key input unit 127.

The RF unit 123 performs wireless communication functions, and includes an RF transmitter (not shown) for transforming a frequency of a transmitted signal into a high frequency signal and amplifying the transformed frequency, and an RF receiver (not shown) for low-noise amplifying a received signal and transforming the frequency of the amplified signal into a low frequency signal. The data processing unit 120 includes a transmitter (not shown) for coding and modulating the transmitted signal, and a receiver (not shown) for demodulating and decoding the received signal. That is, the data processing unit 120 may include a modem and a codec. Herein, the codec includes a data codec for processing packet data, and the like, and an audio codec for processing an audio signal such as voice. The audio processing unit 125 reproduces the audio signal output from the audio codec of the data processing unit 120, or transmits an audio signal generated in a microphone to the audio codec of the data processing unit 120.

The memory 130 may include program memories and data memories. The program memory may store programs for controlling a general operation of the mobile terminal and programs for setting the type of reception notification according to an embodiment of the present invention to control the type of reception notification to be transmitted to a receiver terminal, and for controlling a call reception to be reported by the type of reception notification transmitted from a caller terminal. Further, the data memory temporarily stores data produced while the programs are being performed. The memory 130 stores the type of reception notification, such as a bell/melody, a vibration, a non-audio (lamp or LED flickering), a bell after a vibration, or a vibration after a bell, according to an embodiment of the present invention. Further, each type of reception notification has an inherent identification number.

The control unit 110 controls a general operation of the mobile terminal and may include the data processing unit 120. Further, the control unit 110 sets the type of reception notification of the receiver terminal and controls the type of reception notification to be transmitted to the receiver terminal according to an embodiment of the present invention. Furthermore, the control unit 110 sets the type of reception notification transmitted from the caller terminal as the type of call reception notification of the receiver terminal and controls a call reception to be reported according to an embodiment of the present invention.

The camera unit 140 photographs image data and includes a camera sensor for converting a photographed optical signal into an electrical signal and a signal processor for converting an analog image signal photographed from the camera sensor into digital data. Herein, it is assumed that the camera sensor is a charge coupled device (CCD) sensor and the signal processor may include a digital signal processor (DSP). Further, the camera sensor may be integrated with the signal processor, or the camera sensor and the signal processor may be separate.

The image processing unit 150 generates screen data for displaying an image signal output from the camera unit 140, processes the image signal, which is output from the camera unit 140, by the frame, and outputs frame image data according to a characteristic and size of the display unit 160. Further, the image processing unit 150 includes an image codec, compresses the frame image data displayed in display unit 160 by a predetermined method, or restores the compressed frame image data into original frame image data. Herein, the image codec may include a Joint Photographic Experts Group (JPEG) codec, an Moving Pictures Expert Group 4 (MPEG4) codec, or a wavelet codec, and the like. It is assumed that the image processing unit 150 includes an on screen display (OSD) function, and it may output OSD data according to the size of a displayed screen under the control of the control unit 110.

The display unit 160 displays the image signal, which is output from the image processing unit 150, on a screen, and displays user data output from the control unit 110. Herein, the display unit 160 may use a liquid crystal display (LCD) and may include an LCD controller, a memory capable of storing image data, and an LCD device, etc. Herein, when the LCD employs a touch screen, it may operate as an input unit. The key input unit 127 includes keys for inputting numeral and text information and function keys for setting various functions.

An operation of the mobile terminal will now be described with reference to FIG. 1. After a user performs an operation through the key input unit 127 when a call is originated, if the user sets a calling mode, the control unit 110 detects the calling mode, processes dial information received through the data processing unit 120, converts the processed dialed information into an RF signal through the RF unit 123, and outputs the converted RF signal. Then, when the called subscriber generates a response signal, the control unit 110 detects the response signal through the RF unit 123 and the data processing unit 120. Then, a voice communication path is established through the audio processing unit 125 and the user performs a communication function.

Further, in a receiving mode, the control unit 110 detects the receiving mode through the data processing unit 120 and generates a ring signal through the audio processing unit 125. Then, when the user responds, the control unit 110 detects the response. Further, a voice communication path is established through the audio processing unit 125 and the user performs a communication function. In the calling and receiving mode, an exemplary voice communication has been described. However, a data communication function communicating packet data and image data may also be used. Further, when a standby mode or a text communication is performed, the control unit 110 displays text data processed by the data processing unit 120 on the display 160.

Hereinafter, an operation of controlling the type of reception notification when a communication request occurs in the mobile terminal as described. When the user of the caller terminal sequentially inputs a dialed telephone number, a delimitation mark, and the type of reception notification and transmits them to a base station, the base station detects that the type of reception notification of the receiver terminal has been set through the delimitation mark. The base station sets up the type of reception notification after the delimitation mark in a reserved field of a calling party number when transmitting an alert with an information message to the receiver terminal. When the communication request occurs in the mobile terminal, the control unit 110 detects the type of reception notification set in the reserved bit of the calling party number, and reports a call reception through the received type of reception notification.

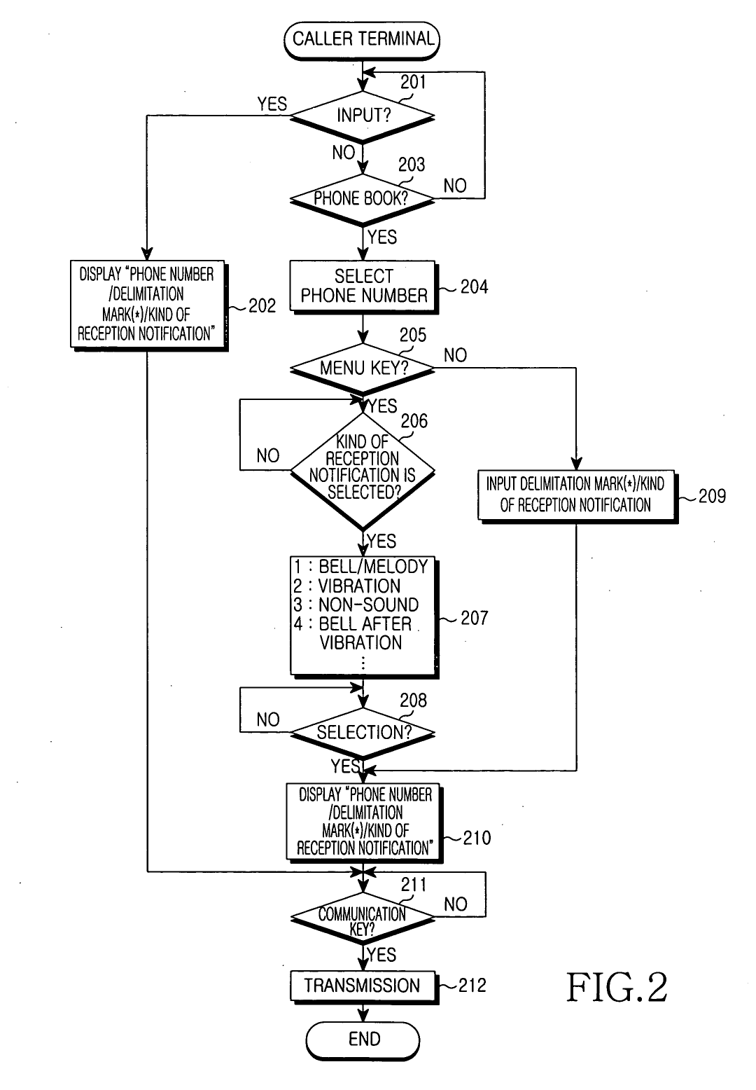

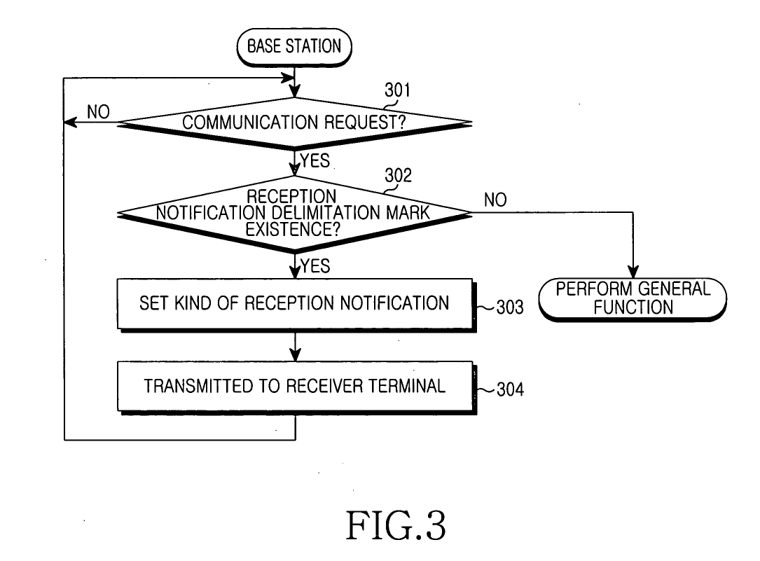

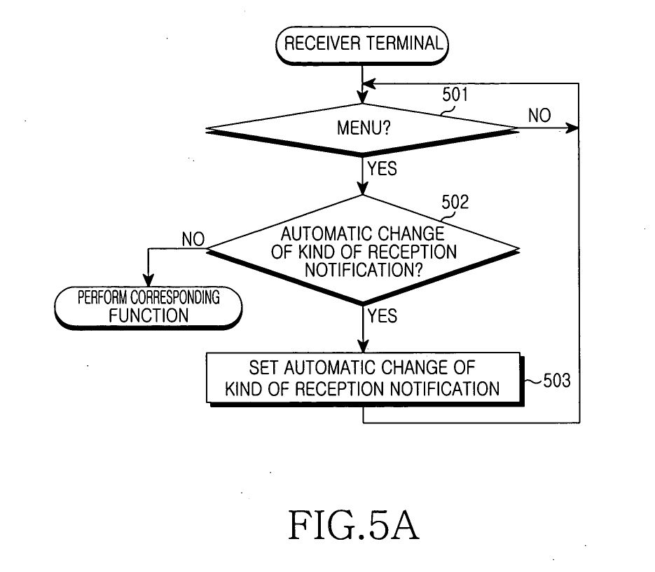

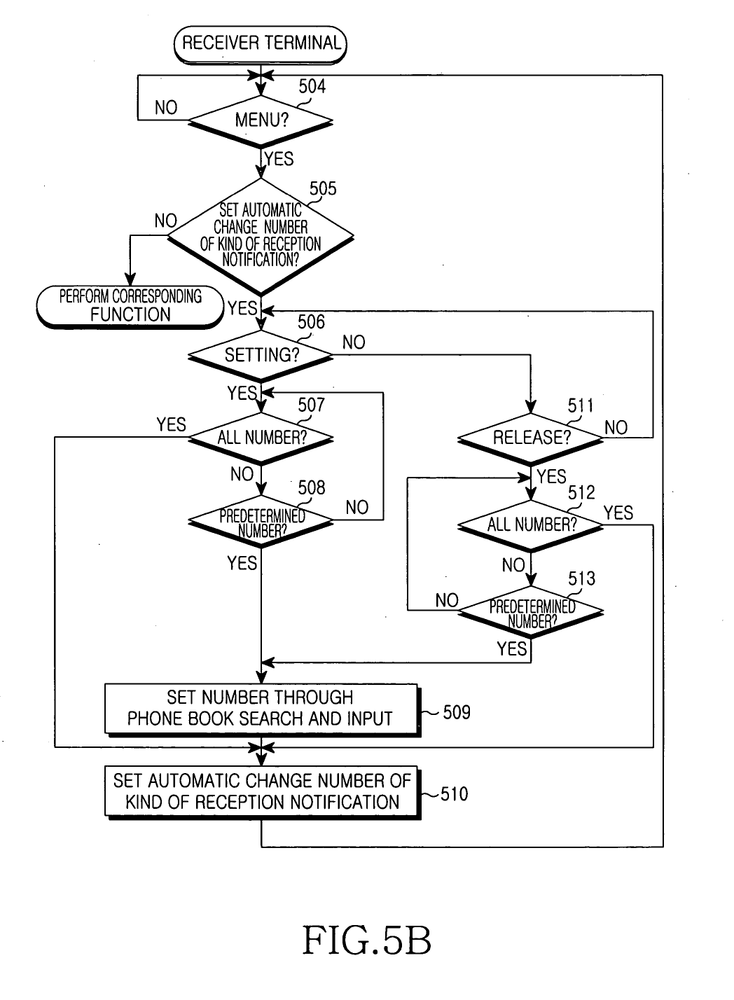

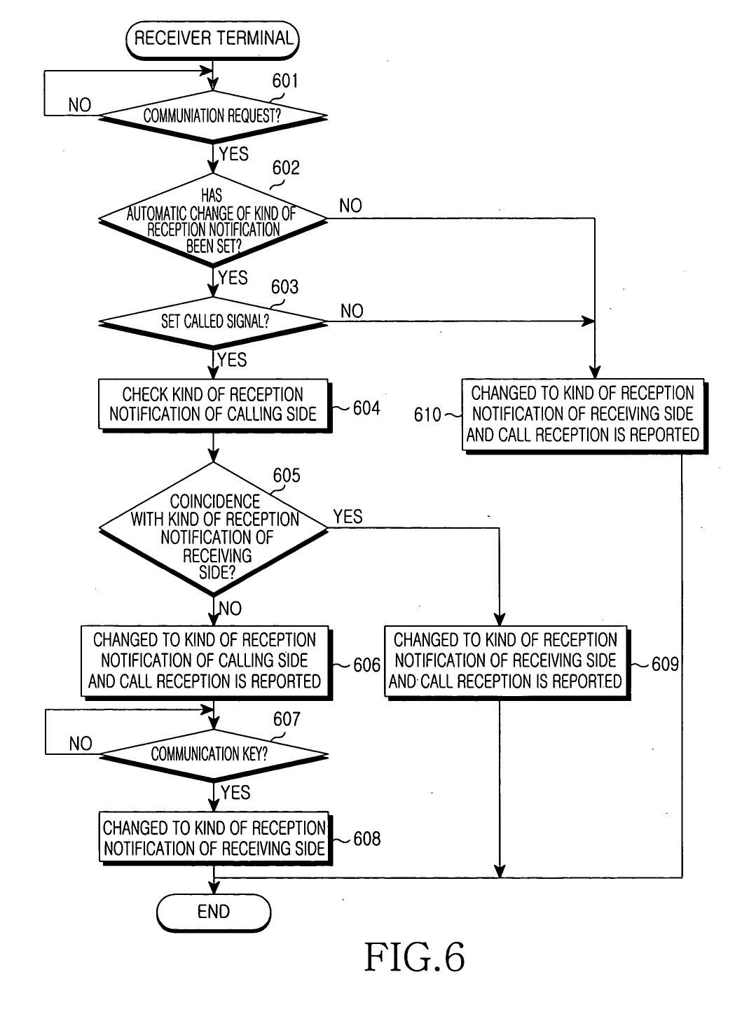

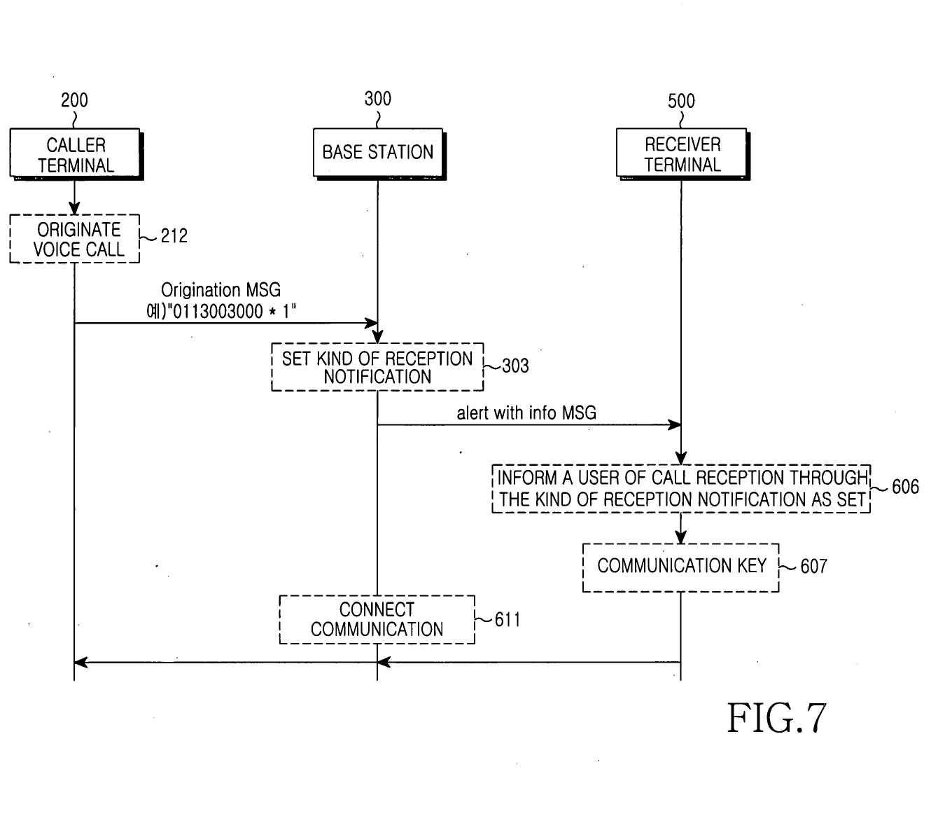

FIG. 2 is a flowchart illustrating a process in which a caller terminal sets and transmits the type of reception notification of a receiver terminal according to an embodiment of the present invention, and FIG. 3 is a flowchart illustrating a process in which a base station sets up the type of reception notification set by a caller terminal and transmits it to a receiver terminal according to an embodiment of the present invention. FIGS. 5A and 5B are flowcharts illustrating a process in which a receiver terminal sets an automatic change of the type of reception notification according to an embodiment of the present invention, FIG. 6 is a flowchart illustrating a process in which the type of reception notification of a receiver terminal is controlled according to an embodiment of the present invention, and FIG. 7 is a flowchart illustrating a process of reporting a call reception according to an embodiment of the present invention. A description will now be given on the assumption that the mobile terminal in FIG. 1 is the receiver terminal. However, the mobile terminal in FIG. 1 may perform the same function as that of the caller terminal according to the embodiment of the present invention.

Referring to FIGS. 2 and 7, when a caller sequentially inputs a telephone number, a delimitation mark, and the type of reception notification in a waiting mode, a control unit of the caller terminal detects the input of the caller in step 201 and controls a display unit to display the input telephone number, the delimitation mark, and the type of reception notification in step 202.

The delimitation mark indicates that the type of reception notification that has been set and may be set as a predetermined character or a character pattern, such as * or #, defined in advance between a base station and a terminal. In an embodiment of the present invention, it is assumed that the delimitation mark is ‘*’, the type of reception notification is a bell/melody (1), a vibration (2), a non-sound (lamp or LED flickering) (3), a bell after a vibration (4), or vibration after a bell (5), and an identifier representing the type of reception notification, that is, a numeral is input after the delimitation mark. The identifier may use not only a numeral but also all patterns capable of being used as the identifier.

Accordingly, when the caller inputs the “bell/melody,” type of reception notification to the receiver terminal having a telephone number of 011-300-3000 as the type of reception notification, the control unit of the caller terminal detects the outgoing call in step 201 and controls the display unit to display 0113003000*1 in step 202. Otherwise, when the caller inputs the telephone number and the delimitation mark (*) and presses a checking key of menu keys or a predetermined key, the control unit displays the type of reception notification. When the caller selects one of the types of reception notification, the control unit detects this selection and controls the selected identification number of the type of reception notification to be automatically displayed after the telephone number and the delimitation mark input by the caller in step 202. Otherwise, when the caller inputs the telephone number and switches a mode of the terminal to a setting mode of the type of reception notification by pressing a predetermined key, such as a hot key or a menu key, or a checking key, the control unit detects the setting mode and controls the type of reception notification to be displayed.

When the caller selects one of the types of reception notification, the control unit detects this selection and controls the delimitation mark and the selected identification number of the type of reception notification to be automatically displayed after the telephone number input by the caller in step 202.

Further, when the caller selects a phone book while in the waiting mode, the control unit detects the selection of the caller and displays stored telephone numbers in step 203. Then, at least one telephone number from among the displayed telephone numbers is selected in step 204. If the menu key is not selected in step 205, the method proceeds to step 209.

In step 209, the delimitation mark is input along with the type of reception notification after the selected telephone number. Herein, the type of reception notification may be selected and displayed through an input of a menu key. When the input has been completed in step 209, the control unit controls the display unit to display the input telephone number, delimitation mark, and type of reception notification. That is, step 210 is performed.

After the caller selects the telephone number in step 204, when the caller selects the type of reception notification from among menus displayed through the input of the menu key in step 205, the control unit detects this selection in step 206. Then, step 207 of displaying the available types of reception notification is performed. When the caller selects one of the available types of reception notification displayed in step 207, the control unit detects this selection in step 208 and controls the display unit to display the telephone number selected by the caller, an automatically generated delimitation mark (*), and the type of reception notification. That is, step 210 is performed.

It should be understood that the foregoing description relates to exemplary ways of generating a telephone number to be dialed, and selecting a type of reception notification. Any other suitable method of generating a telephone number, delimitation mark, and reception notification type could of course be used.

In step 202 or step 210 in which the telephone number, delimitation mark, and type of reception notification are displayed, when the caller presses a communication key, the control unit detects this in step 211 and requests establishment of a communication channel to a base station 300 (see FIG. 7). That is, step 212 is performed. A description will now be given on the assumption that a combination of the telephone number, delimitation mark, and type of reception notification displayed in step 202 or step 210 and transmitted to the base station 300 is 0113003000*1.

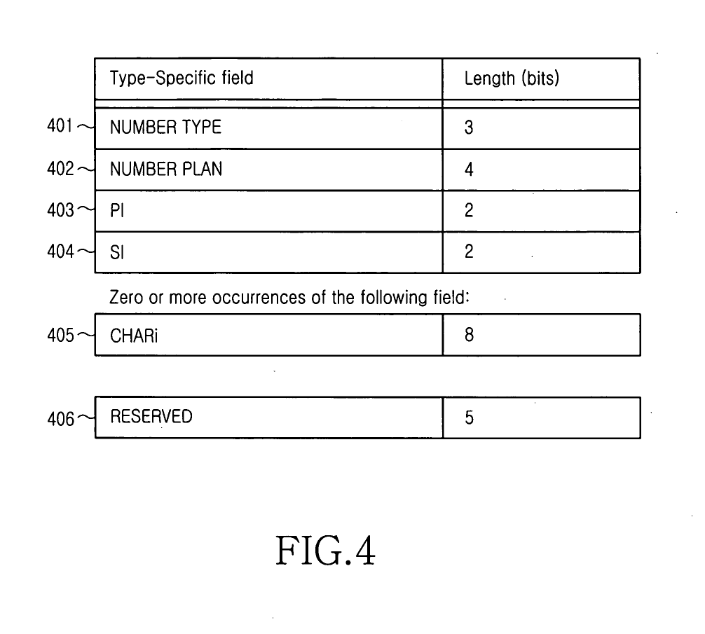

Referring to FIGS. 3 and 7, the base station 300 having received the communication request from the caller terminal 200 detects the request in step 301, and determines whether or not the delimitation mark (*) for setting the type of reception notification of the receiver terminal 500 exists from among information transmitted from the caller terminal 200. From the result of the determination, when the delimitation mark (*) for setting the type of reception notification of the receiver terminal 500 exists, the base station 300 detects the delimitation mark in step 302, and sets up an identification number of the type of reception notification in a reserved field of a calling party number when transmitting an alert with information message to the receiver terminal. In the foregoing example a (1) to indicate the “bell/melody” type of reception notification, would be set by the base terminal. That is, step 303 is performed. The base station 300 transmits the alert with information message for requesting a communication to the receiver terminal 500 (see FIG. 7) together with information on the caller terminal 200. Herein, the base station 300 sets up a ‘1’, that is the identification number behind the delimitation mark (*) representing the type of reception notification, to be the reserved field, of the calling party number, and transmits the reserved field. The message can also include a field, preferably a single bit, indicating the type of message, and in particular identifying the record type to be a record as shown in FIG. 4. The message is a message representing the calling party number and a message field having a structure in FIG. 4 is attached. In step 305, general functions are performed if the delimination mark is not detected at step 302.

FIG. 4 is a view showing a structure of the calling party number. A number type field 401 in FIG. 4 is a number type defined in ANSI T1.607-1990, the entire contents of which is incorporated herein by reference, and may include an unknown (field value is 000), an international number (field value is 001), a national number (field value is 010), a network-specific number (field value is 011), a subscriber number (field value is 100), a reserved (field value is 101), an abbreviated number (field value is 110), and a reserved for extension. A number plan field 402 is a numbering plan defined in ANSI T1.607-1990 and may include an unknown (field value is 0000), an Integrated Services Digital Network (ISDN)/telephony numbering plan (17 and 16) (field value is 0001), a data numbering plan (20) (field value is 0011), a telex numbering plan (19) (field value is 0100), a private numbering plan (field value is 1001), and a reserved for extension (field value is 1111). A PI field 403 is a presentation indicator and represents whether or not a calling number must be displayed. An SI field 404 is a screening indicator and represents a screen processing of a terminal, and a CHARi field 405 represents an actual calling number. A reserved field 406 is a reserved field of five bits. In embodiments of the present invention, the base station 300 sets the reserved field 406 to ‘1’ to identify the type of reception notification and transmits it to the receiver terminal 500. That is, step 304 is performed.

Hereinafter, a process in which the receiver terminal 500 sets an automatic change of the type of reception notification will now be described with reference to FIGS. 1 and 5A. When a user of the receiver terminal 500 presses a menu key on the key input unit 127, the control unit 110 detects the press of the user in step 501 and controls the display unit 160 to display a menu. If the menu is displayed, when the user selects the automatic change of the type of reception notification, the control unit 110 detects the selection in step 502 and allows the automatic change of the type of reception notification to be set. That is, step 503 is performed. Herein, the automatic change of the type of reception notification represents a function capable of reporting a call reception by the type of reception notification set by the caller terminal 200 when a communication request occurs in the receiver terminal 500. In step 504, corresponding functions are performed if there is no automatic change of the type of reception notification in step 502.

FIG 5B is a flowchart illustrating a registration process for a dialed telephone number for performing an automatic change of the type of reception notification. Hereinafter, the registration process of a dialed telephone number for performing an automatic change of the type of reception notification will now be described with reference to FIGS. 1 and 5B. When the user of the receiver terminal 500 presses the menu key on the key input unit 127, the control unit 110 detects the press of the user in step 504 and controls the display unit 160 to display the menu.

In step 514, corresponding functions are performed if the setting of a number for the automatic change of the type of reception notification is not performed in step 505. If the menu is displayed, when the user selects the setting of a number for the automatic change of the type of reception notification, the control unit 110 detects the selection in step 505 and allows setting of a number or release of a number for the automatic change of the type of reception notification to be selected. If the user selects the setting of the number, the control unit 110 detects the selection in step 506 and displays the type of setting of the dialed telephone number used in performing the automatic change of the type of reception notification. If the user selects all numbers from among the type of settings of the dialed telephone number, the control unit 110 detects the selection in step 507 and sets all received dialed telephone numbers as a number used in performing the automatic change of the type of reception notification. That is, step 510 is performed.

If the control unit 110 does not detect the selection of a predetermined number in step 508, the method returns to step 507. Otherwise, if the user selects a predetermined number, the control unit 110 detects the selection in step 508. Then, step 509 of setting the dialed telephone number through a selection in a phone book or a direct input is performed. Next, step 510 is performed, in which the predetermined number set in step 509 is set as a number used in performing the automatic change of the type of reception notification.

In contrast, if the user selects the release of the number, the control unit 110 detects the selection in step 511 and displays the type of release of the dialed telephone number used in performing the automatic change of the type of reception notification. If the user selects all numbers from among the type of release of the dialed telephone number, the control unit 110 detects the selection in step 512 and sets a number for reporting a call reception by the type of reception notification always set in the receiver terminal 500 regardless of the dialed telephone number received in step 510. Otherwise, if the user selects a predetermined number, the control unit 110 detects the selection in step 513. Then, step 509 of setting the dialed telephone number through a selection in a phone book or a direct input is performed. Next, step 510 is performed, in which the predetermined number is set as a number of reporting a call reception by the type of reception notification set in the receiver terminal 500 when the predetermined number set in step 509 is received.

In an embodiment of the present invention, it is assumed that the automatic change of the type of reception notification has been set in the receiver terminal 500 through the aforementioned processes, in which the type of reception notification has been set to be a vibration.

Referring to FIGS. 1, 6, and 7, when the alert with information message for the communication request is received from the base station 300, the control unit 110 of the receiver terminal 500 detects the reception in step 601 and determines whether or not the automatic change of the type of reception notification has been set. As a result of the determination, when the automatic change of the type of reception notification has been set, the control unit 110 detects the set in step 602 and determines whether or not a dialed telephone number for requesting a communication is a registered number. Herein, when the automatic change of the type of reception notification has been released, the control unit 110 detects the release in step 602 and reports a call reception through vibration that is the type of reception notification set in the receiver terminal 500. That is, step 610 is performed.

As a result of the determination, when the dialed telephone number is the registered number, the control unit 110 detects a registration in step 603, searches for a reserved bit of a calling party number, and checks the type of reception notification set in the caller terminal 200. In contrast, when the dialed telephone number is not the registered number, the control unit 110 detects non-registration in step 603 and reports a call reception through vibration, that is, the type of reception notification set in the receiver terminal 500. That is, step 610 is performed.

The control unit 110 having checked the type of reception notification set in the caller terminal 200 determines whether or not a value of the reserved field coincides with that of the type of reception notification set in the receiver terminal 500. As a result of the determination, when the two values match, the control unit 110 detects the match in step 605 and reports a call reception through vibration that is the type of reception notification set in the receiver terminal 500. That is, step 609 is performed.

In contrast, when the two values do not coincide with each other, the control unit 110 detects the difference in step 605, stores the value ‘1’ set in the reserved field in a reception notification value of the receiver terminal 500, and changes the type of reception notification in the receiver terminal 500. That is, step 606 is performed. In step 606, the control unit 110 detects and informs a user of a call reception through a bell/melody that is the changed type of reception notification. When the user having recognized the call reception through the reception notification sound of the bell/melody presses a communication key, the control unit 110 detects the press in step 607 and changes the reception notification sound of the receiver terminal 500 from the changed bell/melody to the vibration that is the original reception notification sound. That is, step 608 is performed. Then, step 611 is performed, (see FIG. 7) in which communication is established between the caller terminal 200 and the receiver terminal 500 through an input of the communication key of the user.

In embodiments of the present invention as described, if a user has a frequent meeting, the user may set their terminal on vibration. The user may forget or neglect to change the type of reception notification on their phone from a vibration to a bell or melody. Further, since there are many cases in which the reception notification type is set as a vibration while a user is asleep, a caller may set the reception notification type as a bell for an urgent call to wake the sleeper. Furthermore, if a user uses public transportation, the calling party may set the reception notification type as vibration to call.

The described embodiments of the present invention have provided examples of different types of call reception notification.

Consequently, in the present invention, a caller terminal controls the type of call reception notification of a receiver terminal, so that a receiver may receive an urgent call which must be received by the receiver without disturbing others. Furthermore, the receiver may conveniently receive a call regardless of the setting of the receiver.

While the invention has been shown and described with reference to certain embodiments thereof, it should be understood by those skilled in the art that various changes in form and details may be made therein without departing from the spirit and scope of the invention as defined by the appended claims.

1. A method of controlling notification of a call reception in a mobile terminal, the method comprising the steps of:
a caller setting a type of reception notification for a receiver terminal and requesting establishment of communication between the caller and the receiver;
determining whether an automatic change of the type of reception notification has been set when the communication request is received in the receiver terminal;
checking the type of reception notification of a calling party transmitted by the caller when the automatic change of the type of reception notification has been set;
comparing the type of reception notification of the calling party with the type of reception notification set in the receiver terminal; and
changing the type of reception notification set in the receiver terminal to the type of reception notification of the calling party and reporting a call reception when the type of reception notification of the calling party does not match the type of reception notification set in the receiver terminal.

2. The method as claimed in claim 1, wherein the caller setting step comprises the steps of:
a caller sequentially inputting a dialed telephone number, a delimitation mark, and the type of reception notification and transmitting them to a base station; and
the base station detecting that the type of reception notification in the receiver terminal is set through the delimitation mark and requesting the establishment of communication with the receiver terminal and the type of reception notification after the delimitation mark.

3. The method as claimed in claim 1, wherein a call reception is reported by the type of reception notification set in the receiver terminal when the automatic change of the type of reception notification is released.

4. The method as claimed in claim 1, wherein a call reception is reported by the type of reception notification set in the receiver terminal when the type of reception notification of the calling party matches the type of reception notification in the receiver terminal.

5. The method as claimed in claim 1, wherein, in the checking, comparing and changing steps whether a dialed telephone number is a registered number is determined when the automatic change of the type of reception notification has been set;
the type of reception notification of the calling party is compared with the type of reception notification set in the receiver terminal when the dialed telephone number is the registered number; and
the type of reception notification set in the receiver terminal is changed to the type of reception notification of the calling party and a call reception is reported when the type of reception notification of the calling party does not match the type of reception notification set in the receiver terminal.

6. The method as claimed in claim 1, wherein a call reception is reported by the type of reception notification set in the receiver terminal when the dialed telephone number is a registered number.

7. A system for controlling an alert setting for a mobile terminal, the system comprises:
a calling terminal adapted to set a type of reception notification for a receiving terminal and request establishment of communication between the calling terminal and the receiving terminal via a base station;
the receiving terminal is adapted to determine whether an automatic change of the type of reception notification has been set when the communication request is received; to check the type of reception notification of a calling party transmitted by the calling terminal when the automatic change of the type of reception notification has been set; to compare the type of reception notification of the calling party with the type of reception notification set in the receiver terminal; and to change the type of reception notification to the type of reception notification of the calling party and report a call reception when the type of reception notification of the calling party does not match the type of reception notification set in the receiver terminal.

8. The system as claimed in claim 7, wherein the calling terminal is further adapted to receive input information from the calling party comprising a dialed telephone number, a delimitation mark, and a type of reception notification and transmit the input information to the base station.

9. The system as claimed in claim 7, wherein the base station is adapted to detect that the type of reception notification in the receiver terminal is set through the delimitation mark and request the establishment of communication with the receiver terminal and the type of reception notification after the delimitation mark.

10. The system as claimed in claim 7, wherein a call reception is indicated by the type of reception notification set in the receiver terminal when the automatic change of the type of reception notification is released.

11. The system as claimed in claim 7, wherein a call reception is indicated by the type of reception notification set in the receiver terminal when the type of reception notification of the calling party matches the type of reception notification in the receiver terminal.

12. The system as claimed in claim 7, wherein the receiving terminal determines whether a dialed telephone number is a registered number when the automatic change of the type of reception notification has been set;
compares the type of reception notification of the calling party with the type of reception notification set in the receiver terminal if the dialed telephone number is the registered number; and
changes the type of reception notification set in the receiver terminal to the type of reception notification of the calling party and reports a call reception if the type of reception notification of the calling party does not match the type of reception notification set in the receiver terminal.

13. The system as claimed in claim 7, wherein a call reception is reported by the type of reception notification set in the receiver terminal if the dialed telephone number is a registered number.
